(19) United States
(12) Patent Application Publication
(10) Pub. No.: US 2024/0282207 A1
(43) Pub. Date: Aug. 22, 2024

(54) SYSTEM AND METHOD FOR INTERACTIVE SCHOOL JOURNAL

(71) Applicant: Raquel Turner, Innisfil (CA)

(72) Inventor: Raquel Turner, Innisfil (CA)

(21) Appl. No.: 18/652,434

(22) Filed: May 1, 2024

Related U.S. Application Data
(63) Continuation-in-part of application No. PCT/IB2022/060568, filed on Nov. 2, 2022.
(60) Provisional application No. 63/274,795, filed on Nov. 2, 2021.

(51) Int. Cl. G09B 5/02

(52) U.S. Cl. CPC G09B 5/02

(57) ABSTRACT

A system and method is provided for recording and analyzing student goals and behaviors. The system includes a teacher and parent user interface for entering the student goals and behaviors, a central server in communication with the user interface for calculating whether the goals are met, plotting the behaviors in a graph or chart and organizing behaviors in a list, and presenting the results on the user interface to the teacher and parent. The method includes entering the student goals and behaviors by a teacher and parent on a user interface, storing the goals and behaviors on a central server in communication with the user interface, calculating whether the goals are met, plotting the behaviors in a graph or chart, listing the behaviors, and presenting whether the student goals are met and the graph, chart or list on the user interface.

The present application is a continuation in part of PCT application PCT/IB2022/060568, filed on Nov. 2, 2022, presently pending. PCT application PCT/IB2022/060568 in turn claimed priority to U.S. provisional 63/274,795 filed on Nov. 2, 2021, presently expired. The contents of each application is hereby incorporated by reference.

### FIELD

The present disclosure relates to a system and method for monitoring student progress. More specifically, the invention relates to an application for recording student behaviors and learning goals.

### BACKGROUND

For some students, learning is challenging, and the learning environment may trigger difficult behaviours. To monitor a student's progress and difficulties, parents and teachers are often tasked with keeping a paper record of the student's behaviour, typically using an Antecedent-Behaviour-Consequence (ABC) chart. In an ABC chart, “A” refers to the antecedent event or activity that precedes a behaviour, “B” refers to the behaviour, and “C” refers to the consequence that follows the behaviour. Entering information in an ABC chart or other record-keeping system is an onerous task for parents and teachers that are already coping with a special student and difficult behaviours. Further, once the information is written down in the chart, it requires an evaluation to make use of the information and apply it to the student's learning goals and a training plan, or to recognize patterns that can help to understand and avoid challenging behaviours.

To address this need, what is required in the field is a system and method for easily recording a student's behaviour, analyzing the behaviour records, and keeping track of whether the student's learning goals are being reached.

### SUMMARY

In the present disclosure, a system and method for recording and analyzing student behaviours and student goals is provided.

Thus by one broad aspect of the present invention, a system is provided for recording and analyzing a plurality of student goals and student behaviours, the system including a central server for storing and processing the student goals and the student behaviours, a teacher user interface (teacher UI) securely communicating with the central server, for entering the student goals and the student behaviors by a teacher, and a parent user interface (parent UI) securely communicating with the central server, for entering the student goals and the student behaviours by a parent, wherein the student behaviours comprise academic achievement, human interactions, eating behavior, sleeping behaviour and acting out behavior, and further wherein the central server processes the plurality of student behaviors, iteratively calculates whether the student goals are met based on one or more of the plurality of student behaviours; plots one or more of the plurality of student behaviours in a graph or a chart and organizes one or more of the plurality of student behaviours in a list, and at least one of the teacher UI and the parent UI presents whether the student goals are met and presents the graph, chart or list of one or more of the plurality of student behaviours.

By a further broad aspect of the present invention, a method is provided for recording and analyzing a plurality of student goals and student behaviours. The method includes entering the student goals using at least one of a teacher user interface (teacher UI) and a parent user interface (parent UI), entering the student behaviours by a teacher using the teacher UI, entering the student behaviors by a parent using the parent UI, storing the student behaviors on a central server in communication with the teacher UI and the parent UI, iteratively calculating whether the student goals are met by the central server based on the student behaviours; plotting one or more of the student behaviours in a graph or chart by the central server, listing one or more of the student behaviours in a list by the central server, and presenting whether the student goals are met and the graph, chart or list on at least one of the teacher UI and the parent UI.

A further understanding of the functional and advantageous aspects of the invention can be realized by reference to the following detailed description and drawings.

### BRIEF DESCRIPTION OF THE DRAWINGS

Embodiments disclosed herein will be more fully understood from the following detailed description taken in connection with the accompanying drawings, which form a part of this application, and in which:

FIG. 1 illustrates a flow diagram of an embodiment of the present disclosure.

### DETAILED DESCRIPTION

The following description and drawings are illustrative of the disclosure and are not to be construed as limiting the disclosure. Numerous specific details are described to provide a thorough understanding of various embodiments of the present disclosure. However, in certain instances, well-known or conventional details are not described in order to provide a concise discussion of embodiments of the present disclosure.

As used herein, “teacher” refers to a classroom instructor, an auxiliary educator in a non-classroom setting, a teacher's aide along with other assistants in the classroom or other learning environment, a counselor in a school or non-school setting, and other professionals or para-professionals responsible for assisting a student.

To address the need for a system and method to easily record and analyze student goals and student behaviours, an interactive school journal is described. The interactive school journal is an application (also referred to herein as an app) that provides a way to enter student goals by a teacher and/or a parent, to easily record student behaviour events and to analyze the student behaviours and calculate whether the student goals are met.

The difficulty in recording behaviour information with pen and paper is the time for a parent or teacher to input the information. Recording behaviour information using pen and paper can take up to half hour for each behaviour event, and parents and teachers of special needs students do not have that time. Also, the app analyzes and integrates the information, to show how often a behaviour is happening, graphs behaviours and related information, and overlays graphs to identify possible patterns and correlations of behaviours. For teachers, the app also eases preparation of report cards. The app also collects health and medical information, such as toileting frequency, by just using a check mark or urine output for a student with a catheter. The app collects information on the student environment, academic goals and achievements, to determine whether the student can do a task or understands the task. Within a school, recording behaviours is not done daily because of the time required, but with the interactive journal, teachers and assistants have the time to input yes/no data, voice record information, etc.

Using the interactive school journal app, student goals are entered into the journal by the parent and/or teacher. Student behaviours are also entered by the parent and/or teacher using the app, with an interface that simplifies data entry. The app presents the behaviours and the goals to the parent and/or teacher in a list format and in graphs or charts. The behaviours are tracked, and they can be seen integrated and overlayed so the parent or teacher can see why behaviour is happening, how to address difficult behaviour and see what next steps should be taken. The parent and/or teacher then modifies the goals and training plan in accordance with the behaviour patterns. Thus, the app is a data tracking app that collects information on behaviour to identify how to modify behaviours and set the next goals.

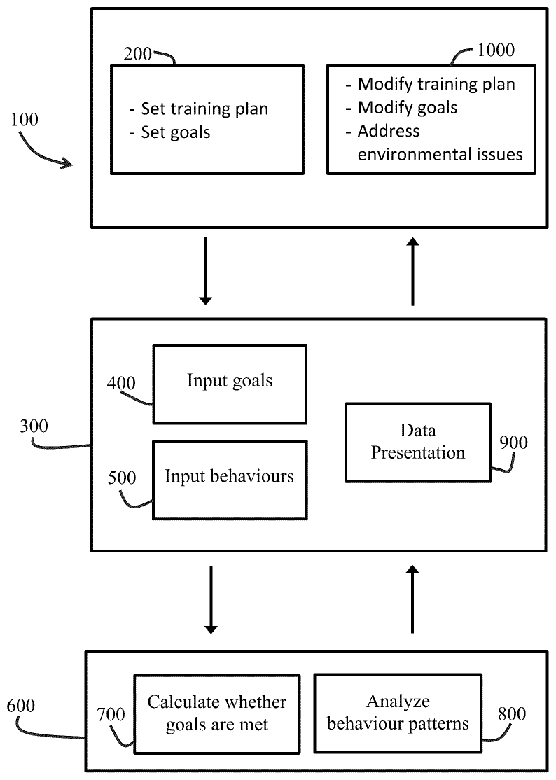

Referring to FIG. 1, the interactive school journal is a computer-implemented system for use by teachers and parents 100. The teachers and parents 100 set a training plan and goals 200 for the student. A user interface 300 includes a teacher UI and a parent UI and is used to enter the student goals 400 and student behaviours 500. The student behaviors 500 include academic achievement, human interactions, eating behavior, sleeping behavior and acting out behavior. The user interface 300 communicates securely with a central server 600. The central server 600 stores and processes the student goals and student behaviours to iteratively calculate whether the student goals are met 700. The central server 600 also analyzes the student behaviours 800 by plotting the student behaviours in a graph or chart and organizing the recorded behaviours in a list, for example, a chronological list. The result of whether the student goals are met 700 and the graphs, charts, and lists of behaviours 800 are presented to the teacher and parent on their respective teacher and parent Uls 300. On the teacher and parent Uls 300, graphs and charts can be overlayed to identify possible correlations between behaviours, behaviour triggers (antecedents), behaviour consequences, or health matters. The parent and teacher may then modify the training plan and goals of the student and address environmental issues 1000, according to the data presented. For example, if a particular antecedent or consequence is associated with a difficult behaviour, that antecedent or consequence may be modified or avoided in the future. As a further example, if the student has been unable to achieve a goal, the goal may be broken down into parts that represent new goals that the student may be able to achieve.

The student behaviour input may include a time the behaviour occurred, a location, an antecedent, a behaviour, and a consequence.

In at least one embodiment, the interactive school journal app includes a student user interface (student UI) for providing student training to the student, which can be tailored to the behaviours and goals recorded in the app.

The present disclosure also provides a method to record and analyze student goals and student behaviours. The method includes setting a training plan and student goals 200 by a parent and/or teacher 100, entering the student goals 400 by a teacher and/or a parent using a teacher UI and parent UI 300 respectively, entering student behaviours 500 by a teacher using the teacher UI and by a parent using the parent UI 300, and storing the goals and behaviour information on a central server 600 that is in secure communication with the teacher and parent UI 300. The student behaviours are used to iteratively calculate whether the student goals are met 700 by the central server 600. The student behaviours are also plotted in a graph or chart 800 by the central server 600 and listed, for example in a chronological list. The results of whether the student goals are met and the behaviour graphs, plots, and lists are presented 900 to the teacher and parent on the teacher and parent UI 300, respectively. The graphs and plots are also overlayed in the teacher and parent UI 300 to identify possible correlations between behaviours, behaviour triggers (antecedents), behaviour consequences, or health matters.

The student behaviours 500 recorded can include a time the behaviour occurred, a location, an antecedent, a behaviour, and a consequence.

The method may also further include presenting student training to the student on a student UI, which can be tailored to the behaviours and goals recorded in the interactive school journal app.

In an embodiment of the present invention, based on the information input by the teachers and parents 100, the app provides a monthly report on behaviors that keep happening and patterns of times and places the behaviors happen. In at least one embodiment, the monthly report is provided through an artificial intelligence (AI) child point of view. For example, the behavior may be that every morning a student walks in a busy coatroom area at 9 am and starts crying, which makes everyone leave the area and the student stops crying. In this example, the app would inform the parent and/or teacher user using AI and a picture of the student that the behavior involves the student crying at 9 am and that a plan of action needs to be taken. An example communication in one embodiment reads: “Hi mom/dad/teacher, as you can see, I have been having trouble when going into the coatroom, and it makes me really sad. I think I could use some help with handling this situation as it is too busy in that area, and it overwhelms me”. In one embodiment, the report is interactive in that the teacher can ask follow up questions, for example, how often a negative emotion is experienced. This is helpful for a teacher and parent who has a non-verbal student and provides teachers/parents the ability to emotionally feel like they can understand and connect with their child.

In a further embodiment, based on a student's struggles with behaviors and school and/or home goals, the app will provide suggestions through the AI child, stating that, based on the information inputted, a change in the goal needs to occur. For example, “Hi mom/dad/teacher, as you can see, I have been having trouble with matching my colours. I think I need some help understanding what is being asked of me”.

In another further embodiment, based on how successful or unsuccessful the student is with their goals, the app will suggest other system-generated goals or supports (such as visuals or timers) to help the student complete the student's goals.

In at least some embodiments, the app interface allows for the gathering of documentation from physical sensors integrated into the device running the app or external sensors. For example, in one embodiment, the app allows the teacher to photograph the students' work product to attach to the report, thereby saving the teacher time in describing the work product. In one embodiment, the interface automatically detects text and performs other image analysis to categorize the photograph, for example, detecting that the photo depicts a worksheet or an art project in progress.

In at least one embodiment, the app communicates with multiple external data stores. For example, the app will communicate with a datastore of student schedules to keep track of student activities and pre-complete fields within reports, such as the classroom where the behaviour occurred. In one embodiment, in place of interfacing with external data stores, the app includes an interface for importing or adding external data and allows for photo scanning of the student's current schedule.

Referring to Appendix 1, an embodiment of the present disclosure is provided in an interactive school journal application (app). The integrated journal includes a shared home and school journal, so that data may be entered by both a teacher and a parent. The app allows the data to remain secure and private between a teacher and a parent. The app provides an integrated school and home journal which can chart, journal, graph and track a student's behaviors and academic progress.

Within the app, the parent and teacher have a secure account (Appendix 1 p. 9-10 and 67-69). From the parent account, an interactive journal may be created for the student, and the student's personal records entered as data for the journal (Appendix 1 p. 11-13). Other data may be entered in the journal, such as teacher name, student goals and student behaviours (Appendix 1 p.15-16). The information to be entered can also be customized by the parent or teacher (Appendix 1 p.20). The integrated journal may include a format for the home journal and a different format for the school journal, wherein the formats have overlapping information, but each format has information relevant to that environment or user (Appendix 1 p. 21-22). The user interface allows data to be entered including text, pictures and circling or choosing icons (Appendix 1 p. 26-27), and in some cases icons may be highlighted if data has been entered for that item (Appendix 1 p. 28).

The teacher user interface may allow a teacher to create and edit a class journal (Appendix 1, p. 71-73). In the class journal, data may be entered by tapping an icon and adding in an image, note, or voice message, or by circling an icon (Appendix 1, p 74-75). Journals for individual students are available on the teacher UI from the class journal, thus, a given student journal can be accessed, customized, and populated with data both from the parent UI and from the teacher UI (Appendix 1, p. 79-87). Further, the app may allow teachers and parents to message or provide notes to each other securely through the app (Appendix 1, p. 90-93).

The app provides data management that is not practical or feasible using a pen and paper record. For instance, the input data from home and school can be used to calculate whether a “smart goal” has been reached (Appendix 1 p. 30, 97). The smart goal includes criteria such as who is assessing the goal and the accuracy level required to reach the goal.

ABC data is easily entered in the journal app (Appendix 1 p. 32-44) by clicking on an appropriate ABC field and filling out information fields that are presented by the app. The entry is time stamped and the time can be modified. Data such as location, activity, antecedent, behaviour, consequence, and duration can be entered using a checkbox and additional information can be optionally added. When ABC data has been entered in the journal app, the corresponding ABC field is highlighted.

The app also allows the data to be listed, graphed, and represented in a variety of formats to the teacher and parent through the teacher and parent user interface (Appendix 1, p. 46-48, 62-63, and 95-103). Graphs can be overlayed to provide insight into behaviour patterns and correlations between behaviours and external events or health issues.

The data collection, management, and presentation by the app allows the teacher and parent to modify the student goals, to move to a further goal if the present goal is reached, or to break down the current goal into more achievable parts if the student is not achieving the goal. The data presentation also allows the teacher and parent to modify a teaching plan to accommodate or avoid the student's difficult behaviours and amplify the student's successful behaviours.

If a student is struggling with an aspect of learning, as evidenced by their academic progress and/or behavior, the student goals can be modified, for instance by breaking down the goals into smaller attainable goals. The app may also provide educational content to the student, based on the student goals, which in turn are based on the recorded student academic progress and behaviours.

Although the invention has been described with a preferred embodiment, it should be noted that the inventor can make various modifications, additions and alterations to the invention without departing from the original scope as described in the present disclosure.

While the applicant's teachings described herein are in conjunction with various embodiments for illustrative purposes, it is not intended that the applicant's teachings be limited to such embodiments. On the contrary, the applicant's teachings described and illustrated herein encompass various alternatives, modifications, and equivalents, without departing from the embodiments, the general scope of which is defined in the appended claims. Except to the extent necessary or inherent in the processes themselves, no particular order to steps or stages of methods or processes described in this disclosure is intended or implied. In many cases the order of process steps may be varied without changing the purpose, effect, or import of the methods described.

What is claimed is:

1. A computer-implemented system for recording and analyzing a plurality of student goals and a plurality of student behaviors, the system comprising:
a central server for storing and processing the student goals and the student behaviors;
a teacher user interface (teacher UI) securely communicating with the central server, for entering the student goals and the student behaviors by a teacher; and
a parent user interface (parent UI) securely communicating with the central server, for entering the student goals and the student behaviors by a parent;
wherein the student behaviors comprise:
academic achievement;
human interactions;
eating behavior;
sleeping behavior; and
acting out behavior;
and further wherein
the central server:
processes the plurality of student behaviors;
iteratively calculates whether the student goals are met based on one or more of the plurality of student behaviors;
plots one or more of the plurality of student behaviors in a graph or a chart; and
organizes one or more of the plurality of student behaviors in a list;
and at least one of the teacher UI and the parent UI:
presents whether the student goals are met; and
presents the graph, chart or list of one or more of the plurality of student behaviors.

2. The system of claim 1, further wherein one or more of the student behaviors comprise:
a time;
a location;
an antecedent;
a behavior; and
a consequence.

3. The system of claim 1, further comprising a student user interface (student UI) for providing student training based on the student behaviors.

4. The system of claim 1, wherein the at least one of the teacher UI and the parent UI presenting the plurality of student behaviors comprises presenting a behaviour using an artificial intelligence child to represent the student.

5. The system of claim 1, wherein the at least one of the teacher UI and the parent UI presenting whether the student goals are met further comprises presenting a change in the student goals using an artificial intelligence child to represent the student.

6. The system of claim 1, wherein the at least one of the teacher UI and the parent UI presenting whether the student goals are met further comprises providing at least one of system-generated goals or system-generated supports for helping the student complete the student goals.

7. A method for recording and analyzing a plurality of student goals and student behaviors, the method comprising:
entering the student goals using at least one of a teacher user interface (teacher UI) and a parent user interface (parent UI);
entering the student behaviors by a teacher using the teacher UI;
entering the student behaviors by a parent using the parent UI;
storing the student behaviors on a central server in secure communication with the teacher UI and the parent UI;
iteratively calculating whether the student goals are met by the central server based on the student behaviors;
plotting one or more of the student behaviors in a graph or chart by the central server;
listing one or more of the student behaviors in a list by the central server; and
presenting whether the student goals are met and the graph, chart or list on at least one of the teacher UI and the parent UI.

8. The method of claim 7, wherein one or more of the student behaviors comprise:
a time;
a location;
an antecedent;
a behavior; and
a consequence.

9. The method of claim 7, further comprising presenting student training based on the plurality of student behaviors on a student user interface (student UI).

10. The method of claim 7, wherein the presenting the graph, chart or list of the student behaviors comprises presenting a behaviour using an artificial intelligence child to represent the student.

11. The method of claim 7, wherein the presenting whether the student goals are met further comprises presenting a change in the student goals using an artificial intelligence child to represent the student.

12. The method of claim 7, wherein presenting whether the student goals are met further comprises providing at least one of system-generated goals or system-generated supports for helping the student complete the student goals.
